(19) United States
(12) Patent Application Publication
(10) Pub. No.: US 2018/0119364 A1
(43) Pub. Date: May 3, 2018

(54) Transportation Matting

(71) Applicant: XCraft, Inc., Boston, MA (US)

(72) Inventor: Robert A. DaSilva, Reading, MA (US)

(21) Appl. No.: 15/795,373

(22) Filed: Oct. 27, 2017

Related U.S. Application Data
(60) Provisional application No. 62/413,482, filed on Oct. 27, 2016.

(51) Int. Cl. E01C 9/08

(52) U.S. Cl. CPC E01C 9/086; B29C 70/48

(57) ABSTRACT

Transportation matting for traversing soft ground surfaces, such as beaches and muddy roads, is provided. The matting is thin, rollable, and lightweight (in some embodiments, about 1 lb/ft²) and has a convoluted configuration with alternating peaks and valleys formed from mats of a fiber reinforced polymer composite material. The matting is coilable with a preload by which the matting tends to unroll and lay flat, while retaining relatively high compliance or ease of roll-up when recovered.

### CROSS REFERENCE TO RELATED APPLICATIONS

This application claims the benefit under 35 U.S.C. § 119(e) of U.S. Provisional Application No. 62/413,482 filed on Oct. 27, 2016, the disclosure of which is incorporated herein by reference.

### STATEMENT REGARDING FEDERALLY SPONSORED RESEARCH OR DEVELOPMENT

The invention was developed with financial support under Contract No. M67854-11-C-6501 and No. M67854-13-C-6501 from the U.S. Marine Corps. The U.S. Government has certain rights in the invention.

### BACKGROUND

Soil stabilization systems such as matting are often employed by the military over expeditionary soft soil terrain including beaches and muddy roadways. Armoring already heavy tactical vehicles such as the MK23 MTVR (Medium Tactical Vehicle Replacement) has increased ground pressure to the extent that traversing soft soil equivalent to tilled farmland (California Bearing Ratio of 3—CBR3) is not possible without application of novel soil stabilization systems. The Navy has described the need for soil stabilizing matting that is reusable, durable, provides good soil stabilization, is compact, low weight, and allows rapid deployment. Solutions must also be affordable to purchase.

Current solutions center on rapidly-deployable and recoverable road surfaces. One presently-used legacy transportation matting system, called MOMAT, exhibits acceptable cost and performance but is no longer in production. Alternative systems do not meet performance expectations, and/or are either too heavy or too expensive.

Dimensionally, the matting is typically 12 to 14 feet wide, and is shipped and deployed in sections (often spooled) of up to 60 feet long. Expedient deployment of the matting system is defined as the placement of 2,500 square feet per man hour. Soil stabilization failure of an employed matting system is indicated by soil ruts of greater than 6 inches deep or sustained matting system damage of at least 20%.

### SUMMARY

A soil stabilization transportation product provides a thin, roll-able, lightweight matting (1 lb/ft²), used to improve vehicle passage over soft soil and sandy terrain (California Bearing Ratio of 3 or higher). The matting is comprised of a convoluted substrate with alternating peaks and valleys comprised of fiber reinforced polymer composite construction, featuring a vehicle “traction enhancing” top surface and smooth bottom surface placed against the soil when deployed. The synergy of the geometric and constitutive mechanical elements yields an anisotropic mechanical behavior characterized by very high vehicle support stiffness and soil stabilization over soft soils when deployed (unrolled and laid-flat), but with relatively high compliance or ease of roll-up when recovered. In some embodiments, the transportation matting is comprised of a plurality of bonded matting panels that when joined and laid flat, result in matting that measures 14 feet wide by 60 feet long and between 3.5 feet to 4.5 feet in diameter when recovered and coiled-up. The invention has been manufactured at full scale and demonstrated by the military to meet all of the transportation matting requirements for form, cost, and performance.

### DESCRIPTION OF THE DRAWINGS

Reference is made to the following detailed description taken in conjunction with the accompanying drawings in which:

FIG. 1 is an isometric view of an embodiment of transportation matting in the rolled or coiled state with detail views -A- and -B- of the transportation matting surface geometry;

FIG. 2 is an isometric view of an MTVR truck driving over the transportation matting with a detail view -A- of a composite doubler feature local to a drag hole;

FIG. 3 is an isometric view of the transportation matting being deployed or uncoiled by two people;

FIG. 4 is a side view of the transportation matting in the coiled state with a cross-sectional view along line Z-Z of 3rd angle projection;

FIG. 5 is an isometric view of a square section of the transportation matting with a plan view of the matting section having a cross-sectional view along line Z-Z taken parallel to the side of the matting, with a corresponding detail view -A- of the cross-section showing matting geometric undulation, and a cross-sectional view along line Y-Y taken 45 degrees to the side of the matting with a corresponding detail view -B-;

FIG. 6 is a plan view of the transportation matting of FIG. 5 with a peak detail view -D- and cross-sectional view along X-X and corresponding detail view -C-;

FIG. 7 is an isometric view of two large sections of transportation matting prior to joining via adhesive, with corresponding detail view -B-;

FIG. 8 is an isometric view of the transportation matting of FIG. 7 after joining via adhesive, with a corresponding detail view -A- and a cross-sectional view along line F-F showing the adhesive bond line;

FIG. 9 is an isometric view of a section of the transportation matting showing the orientation of the matting;

FIG. 10 is a plan view of the transportation matting of FIG. 8 with a cross-sectional view along line F-F showing the adhesive bond line and traction enhancing grit on the top surface and smooth bottom surface;

FIG. 11 is an isometric exploded view of the transportation matting manufacturing via Light Resin Transfer Molding (LRTM) showing a top and bottom tool with dry fiberglass non-crimp mat placed between;

FIG. 12 is an isometric exploded view of the transportation matting manufacturing via Light Resin Transfer Molding (LRTM) showing a top and bottom tool with dry fiberglass non-crimp mat placed on the bottom tool and covered with grit;

FIG. 13 is an isometric view of transportation matting manufacturing via Light Resin Transfer Molding (LRTM) showing the closed LRTM mold and resin infusion;

FIG. 14 is an isometric exploded view of transportation matting manufacturing via Light Resin Transfer Molding (LRTM) showing a top and bottom tool with a molded and cured piece of the transportation matting between;

FIG. 15 is an isometric view of a representative test piece of transportation matting placed in an orthogonal orientation between a loading nose cylinder and two support cylinders for 3-point bending;

FIG. 16 is an isometric view of a representative test piece of transportation matting placed in a diagonal or bias orientation between a loading nose cylinder and two support cylinders for 3-point bending;

FIG. 17 is a picture of a section of legacy matting laid over the tooling of the transportation matting described herein; and

FIG. 18 is a table containing data generated by the transportation matting described herein and the legacy matting in 3-point bend tests.

### DETAILED DESCRIPTION

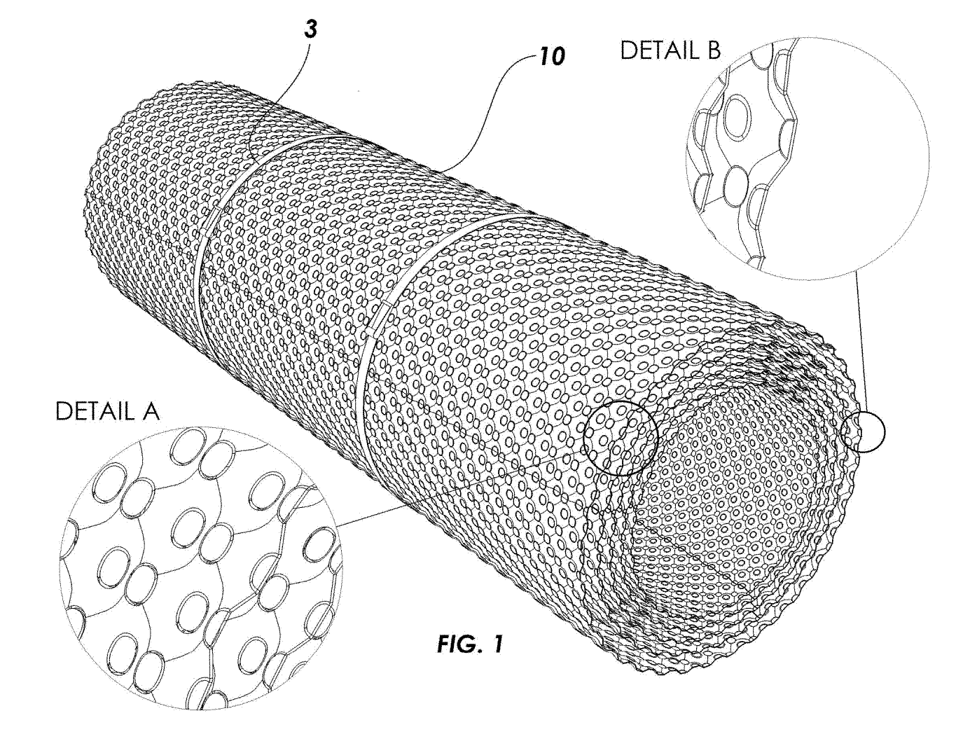

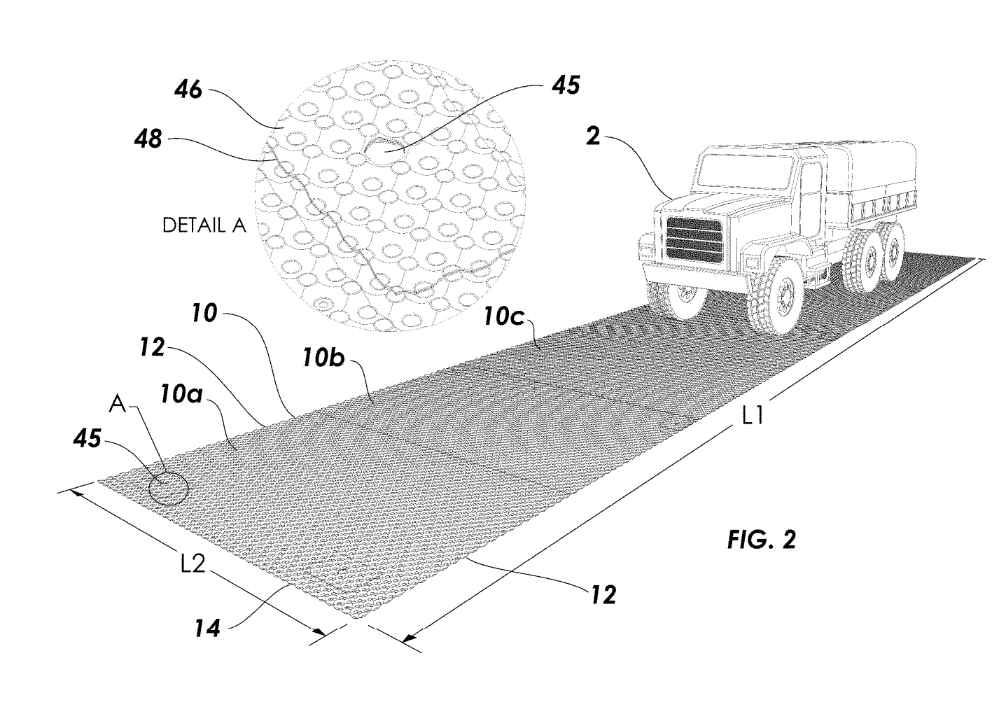

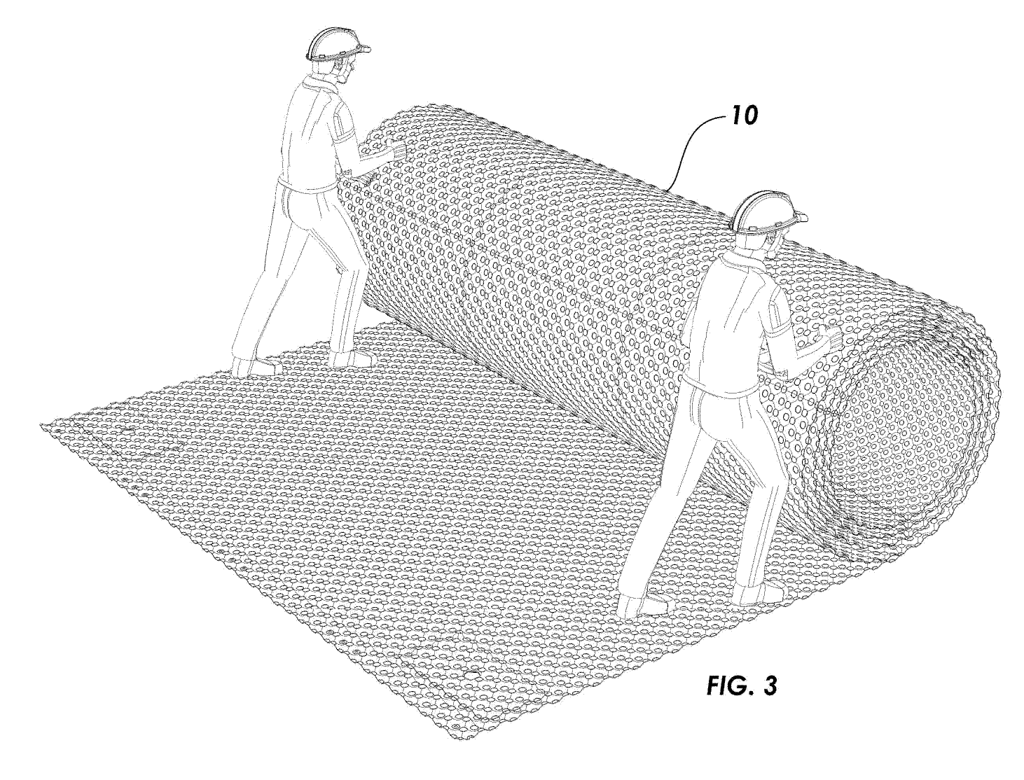

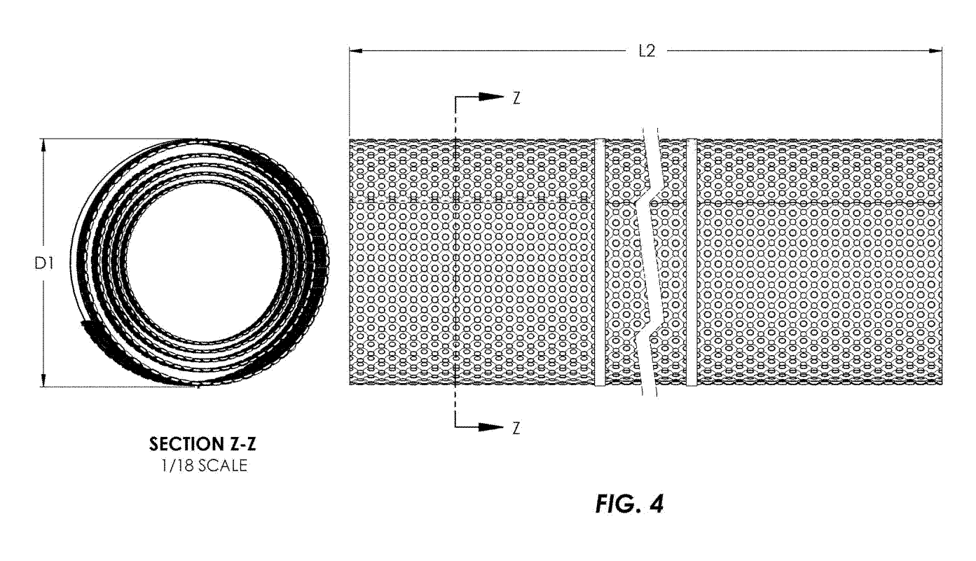

Embodiments of transportation matting 10 are described by reference to FIGS. 1-18. FIGS. 1 and 4 illustrate an embodiment of transportation matting in a rolled or coiled position prior to deployment on a ground surface. FIG. 3 illustrates the transportation matting being deployed by two people. FIG. 2 illustrates a length of transportation matting deployed on a ground surface with a vehicle driving over the transportation matting. As can be seen in FIG. 2, the matting 10 can be provided in sections 10a, 10b, 10c, and the like. The matting or each section thereof includes side edges 12 that extend in a longitudinal direction, parallel to dimension L1, which is the direction in which a vehicle can drive over the matting. Each section includes end edges 14 that extend in a width direction, parallel to dimension L2.

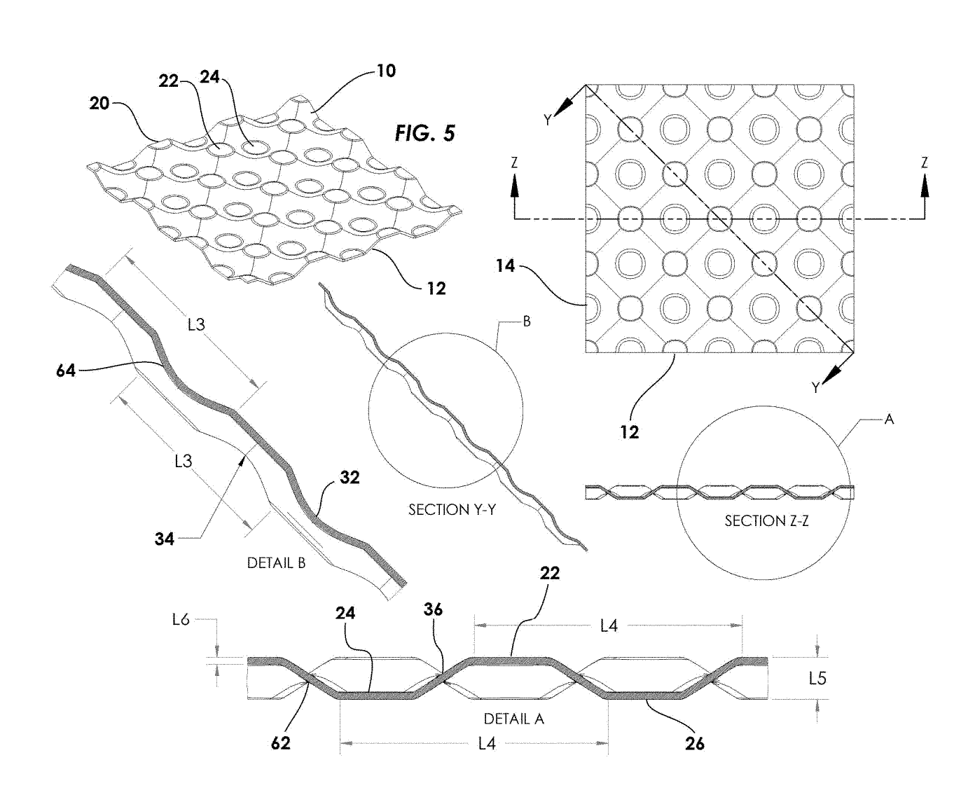

Referring more particularly to FIG. 5, in some embodiments the transportation matting geometry is described by a convoluted wave form or surface configuration 20 with alternating peaks 22 and valleys 24. In some embodiments, the matting can have a wall thickness L6 of 1/10 of an inch. The wave form or surface configuration is represented by a 3-dimensional truncated sine wave. In some embodiments, the truncated sine wave has an amplitude of 5/16 of an inch, and total matting thickness envelope L5 of ⅝ of an inch (measured from peak 22 on the upper surface to valley underside 26). See Section Z-Z and Detail A of FIG. 5. Peaks and valleys are oriented in an orthogonal repeating pattern, with the largest peak-to-peak measurement L4 running parallel to the side edges 12 and end edges 14 of the matting, defined as the orthogonal direction. In some embodiments, the in-plane distance between adjacent or repeating peaks L4 (also described as the wavelength or peak-to-peak distance) measured parallel to the edges of the matting is 4 inches, while the in-plane peak-to-peak distance in the bias or diagonal direction L3 (±45 degrees from the edges of the matting) is 2.83 inches. See Section Y-Y and Detail B of FIG. 5. In some embodiments, the orthogonal peak-to-peak distance L4 can range from 3 inches to 5 inches. In some embodiments, the diagonal peak-to-peak distance L3 can range from 2.12 inches to 3.54 inches. The distance between peaks is equal to the distance between valleys for both orthogonal and diagonal directions. The curved regime located between the peaks in the diagonal or bias direction is known as the saddle region 32, with a cusp 34 existing midway between peaks at the inflection 34 of the saddle.

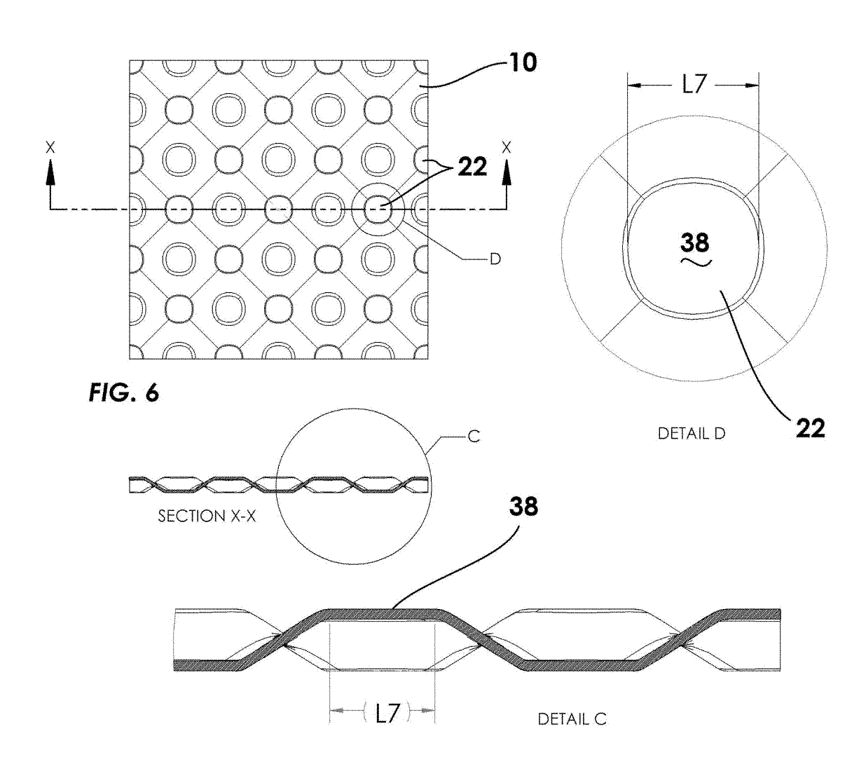

In referring to FIG. 6, truncating or clipping the peaks 22 of the waveform creates a platform section 38 at each instance in the plan view, with a squircle (square+circle) shape where the sides of the square section are arched in a convex form, having rounded corners, and a length and width, indicated by L7, of about 1 inch±0.2 inches.

The transportation matting is constructed from mats of glass reinforcing fibers embedded in a resin matrix. In some embodiments, the matting is constructed from mats of non-crimp biaxial (±45°) E-glass grade fiberglass embedded in an elastomer modified epoxy vinyl ester resin system matrix with high tensile elongation at failure. In some embodiments, the tensile elongation at failure is equal to or greater than 8%. A suitable commercially available resin system matrix is Ashland Derakane 8084 epoxy vinyl ester resin; other commercially available suitable resin systems include Interplastics CoREZYN CORVE 8550 and the greater CORVE resin series, as well as Sade, Inc. (of Lincoln, Nebr.) SI-BAQ-6, SI-A2442A, and SI-A2443A resin. In some embodiments, the glass fiber can be S-glass fibers or a combination of E-glass fibers and S-glass fibers.

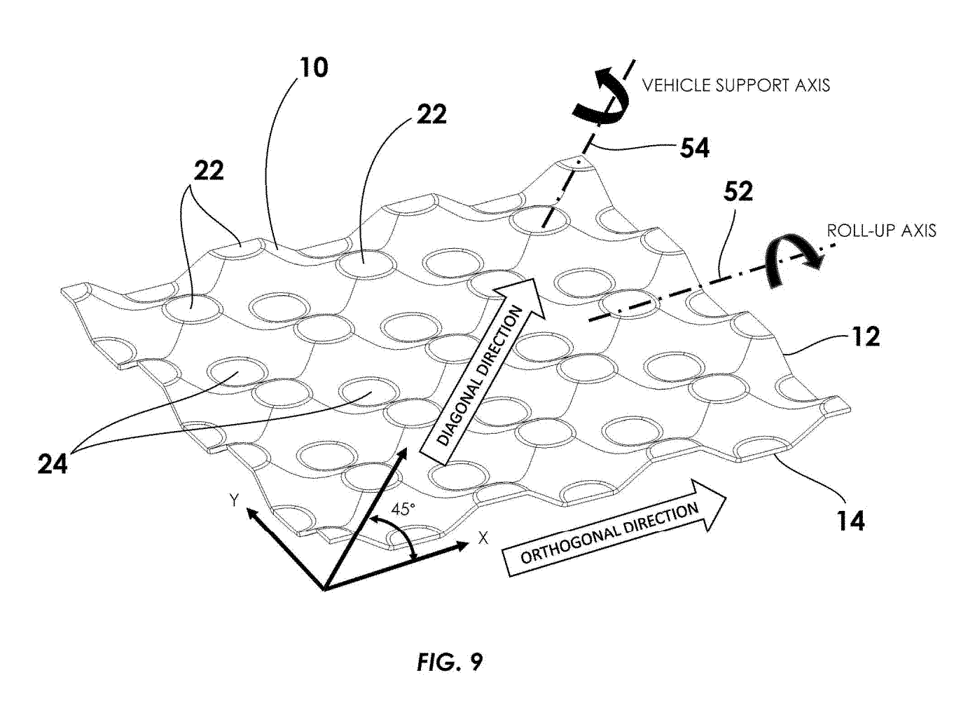

In some embodiments, two different weight non-crimp mat cloths of 24 oz/yd² and 18 oz/yd² are used to reinforce the resins system with E-glass fibers biased or oriented ±45 degrees from the transportation matting edges 12, 14. The ply schedule comprises four non-crimp mat biaxial fiberglass layers with two 18 oz/yd². mat cloths at the center and two 24 oz yd² mat cloths as the outer layers [24 oz/18 oz/18 oz/24 oz]. The mat cloths are laid up in a mold for resin infusion, described further below. In FIG. 9 the orthogonal and diagonal directions are illustrated.

In some embodiments, each fiberglass mat cloth can be constructed from a collection of thinner plies containing fiberglass tows that are not interlaced or woven (ie: non-crimp). Instead, tows are loosely gathered or stitched in parallel architectures or unidirectional plies. Gathered or stitched plies are then joined or stitched to one-another to build mats with varying ply orientations. These materials are considered “non-crimp” mats or cloths as no tow undulation or crimping occurs, unlike as with wovens, and results in a stiffer composite. Stitched mats are available in many architectures; uniaxial (0°), biaxial (±45°), 0°/90°, quasi-isotropic (0°/45°/90°/−45°), and custom. In the case of the transportation matting, biaxial (±45°) non-crimp stitched mats are suitable, although other architectures can be used.

Resulting molded and cured transportation matting composite properties include an areal density of 1.15 lb/ft², a fiber volume fraction of 63%, a void content equal to or less than 1.6%, a degree of cure of 99%, and a glass transition temperature of 207° F.

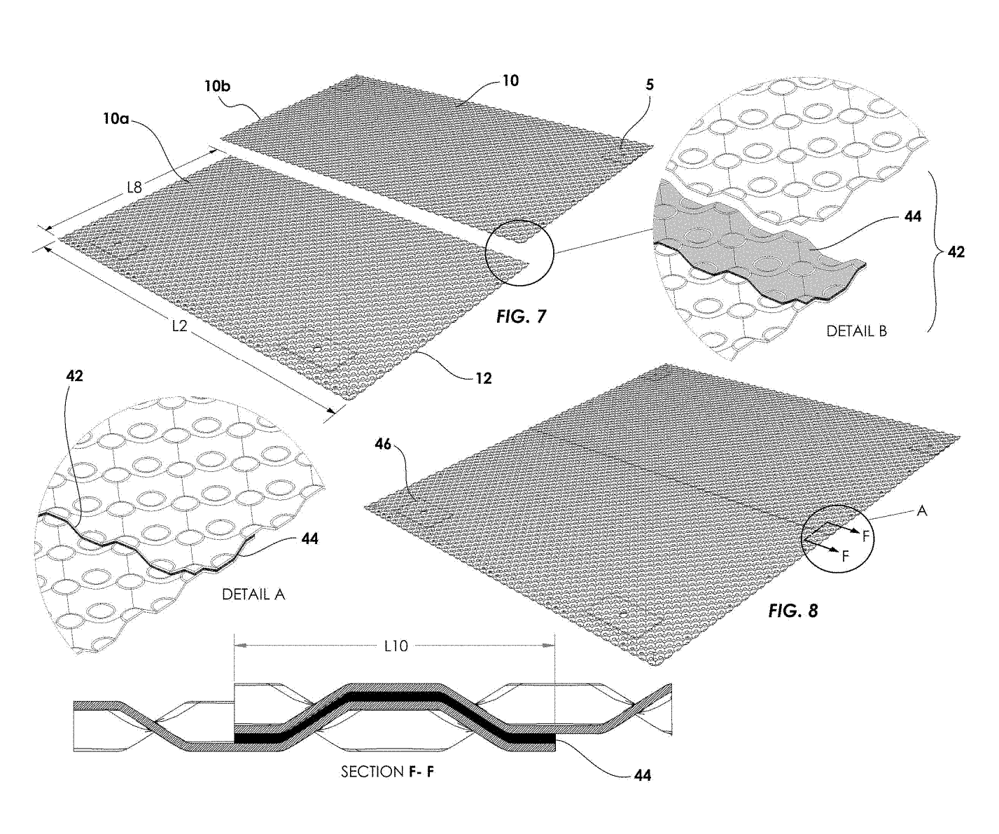

In referring to FIG. 7, in some embodiments the transportation matting 10 can include multiple sections or panels 10a, 10b of matting joined along overlapping seams 42 with an adhesive 44. Any suitable adhesive can be used, such as a methyl methacrylate, an epoxy, urethane, or a polyurethane. A methyl methacrylate adhesive (MMA) called Plexus MA310 adhesive is a commercially available suitable adhesive. In referring to FIG. 7, in some embodiments, panels can measure 8 feet (L8)×14 feet (L2). In referring to FIG. 8, some embodiments can have panels joined with a 4 inch overlap L10 serving as the adhesive regime 44. In some embodiments, the overlapping seams can have a shear strength of at least 2000 psi based on ASTM D3164 testing method for strength properties of adhesively bonded plastic lap-shear sandwich joints in shear by tension loading.

As shown in the deployed state of FIG. 2, in some embodiments eight panels are joined to form a transportation matting 10 with dimensions 14 feet wide L2 by 60 feet long L1. In some embodiments, the matting is wide enough to facilitate the traversing of vehicles such as the MTVR truck 2 and M1 Abrams tank. In some embodiments, holes or penetrations 45 can be made in the matting, for example, along a peripheral region, to facilitate moving or dragging the matting into position and staking of the matting when deployed. Composite doublers 46 fabricated from cut sections of transportation matting can be bonded at 48 or otherwise fastened to the matting top surface local to the holes or penetrations to thicken the composite matting and improve strength.

As shown in FIGS. 1, 3, and 4, the matting 10 is coilable with a preload, whereby the matting tends to unroll and lay flat. The tendency of the transportation matting to unroll or self-deploy in the coiled state once retaining straps 3 are removed is due to the stiffness preload of the material in the coiled state.

In some embodiments, the transportation matting 10 can be lifted in coiled form onto a truck via lifting slings or forklift, and transported to the service location where it is generally rolled or slid-off the truck onto the ground by hand. In referring to FIG. 3, once on the ground, two personnel are generally sufficient to handle and roll the matting 10 into position, typically standing at either end of the roll. Once positioned, the matting retaining straps are released and the transportation matting self-deploys, uncoiling until laid-flat.

In some embodiments the transportation matting 10 can unroll or uncoil in less than 1 minute once the retaining straps are released, with transportation matting deployment being equal to a placement of at least 5,000 square feet per man hour and as much as 50,000 square feet per man hour. In some embodiments the transportation matting can be recovered with only two personnel standing at either side, coiling the matting.

In referring to FIG. 4, in some embodiments a recovered and fully coiled transportation matting 10 has an outside diameter D1 of between 3.5 feet and 4.5 feet and length L2 of between 12 feet and 14 feet. When coiled, the transportation matting shape is retained with strapping 3.

The transportation matting is compliant enough to roll-up, yet stiff enough to support a 55,000 lb MTVR truck traversing its substrate over soft soil terrain. In referring to FIG. 9, it was determined through computer simulation using Finite Element Analysis combined with mechanical test data, that good prediction for the roll-up ease and vehicle support characteristics could be determined by isolating two primary orientations of the transportation matting. When flexure is applied about the orthogonal or roll-up axis 52, the material folds readily about the nodes created by the intersecting peaks 22 and valleys 24 of the matting geometry. When rotating the matting 45 degrees in the plan view and applying the same flexure about the diagonal or support axis 54, the material is instead rigid-ized by arches formed by the same undulating peaks and valleys which substantially increase the area moment of inertia. In some embodiments, stiffness increases about 6 times when transformed from the roll-up to vehicle support (also denoted as diagonal) directions. This directionally dependent moment of inertia in combination with the biased reinforcing fiber provides flexibility in the roll-up direction and rigidity in the biased or diagonal direction. This structural dichotomy is the predominant mechanism which makes the transportation matting so effective in soil stabilization at such low weight.

In the case where the transportation matting is constructed of an isotropic material, transportation matting described herein is about 2.3 times stiffer in flexure about the diagonal vs. orthogonal or length and width axis due to its geometric characteristics. When the material constituency is of composite construction using biased fiber orientation in a resin matrix, the flexural stiffness difference between diagonal and orthogonal directions becomes augmented, being about 6 times greater in the diagonal than the orthogonal orientation.

In referring to FIG. 5, sectioning the matting reveals the geometric elements which make this behavior possible. When sectioning through the roll-up axis along line Z-Z (parallel to the edges 12, 14) of the transportation matting, a series of nodes 36 can be seen occurring at the inflection points 62 created between convoluted peaks. It is at these nodes where the overall thickness envelope of the matting is reduced to the wall thickness, allowing the structure to bend and flex with relative compliance about these nodes. Conversely, when sectioning the matting through the diagonal direction along line Y-Y, the structure is comprised of a series of arches 64 occurring in the saddle region 32 between peak instances. These arches 64 provide a much greater area moment of inertia and associated stiffness, and thus carry the bulk of the vehicle stabilization and support loads.

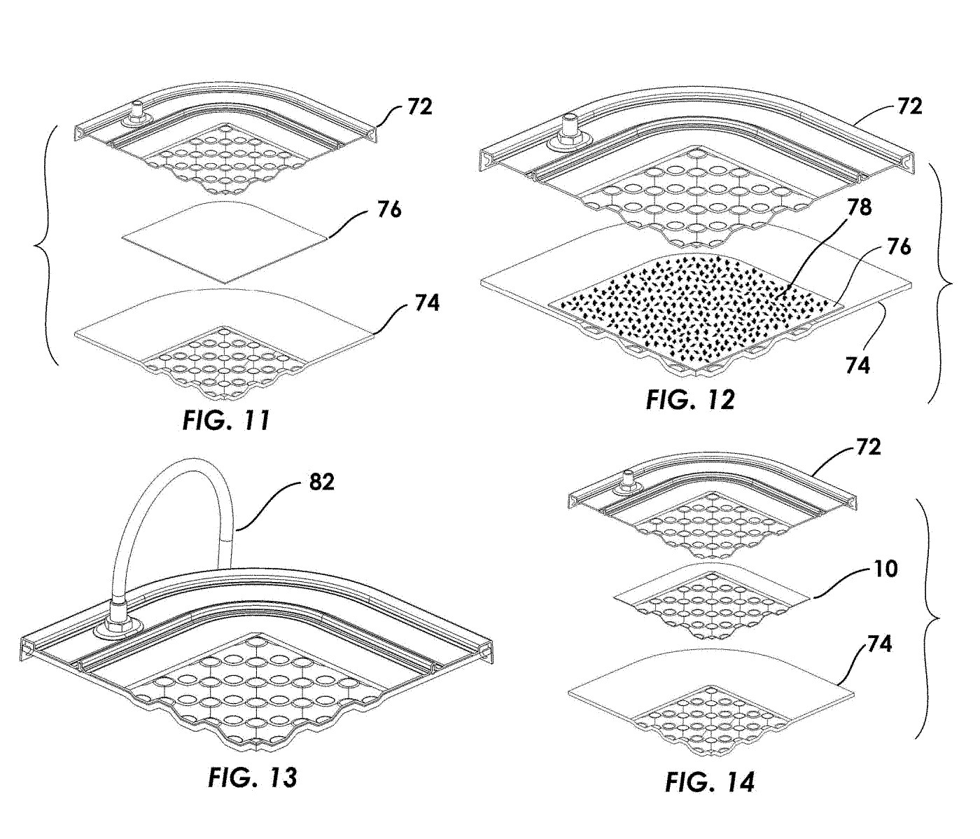

In referring to FIGS. 11-14, in some embodiments the transportation matting is manufactured by a closed mold process using Resin Transfer Molding (RTM), Light Resin Transfer Molding (LRTM), or Vacuum Assisted Resin Transfer Molding (VARTM). For example in FIG. 11, the manufacturing tooling is comprised of top 72 and bottom 74 matched molds which contain the convoluted transportation matting surface geometry. Layers or mats of the E-glass reinforcing fiber 76 are placed over the bottom mold surface, for example, with the 24 oz/yd² non-crimp mat being placed first, followed by two layers of 18 oz/yd² non-crimp mats, followed by another layer of 24 oz/yd² non-crimp mat. The fiber layers are then debulked and pre-formed to the bottom tooling surface.

In referring to FIG. 12, granular or grit material 78 is disbursed over the pre-formed fiber layers 76 prior to the top mold 72 being positioned to close the mold. In some embodiments black aluminum oxide serves as the grit material. In referring to FIG. 13, resin is introduced into the closed mold via hosing 82 where the grit material functions as the resin flow media, aiding resin infusion of materials inside the mold during transportation matting infusion and molding. The grit material is “co-molded” and cured along with the reinforcing fibers and resin matrix inside the mold during transportation matting infusion and molding.

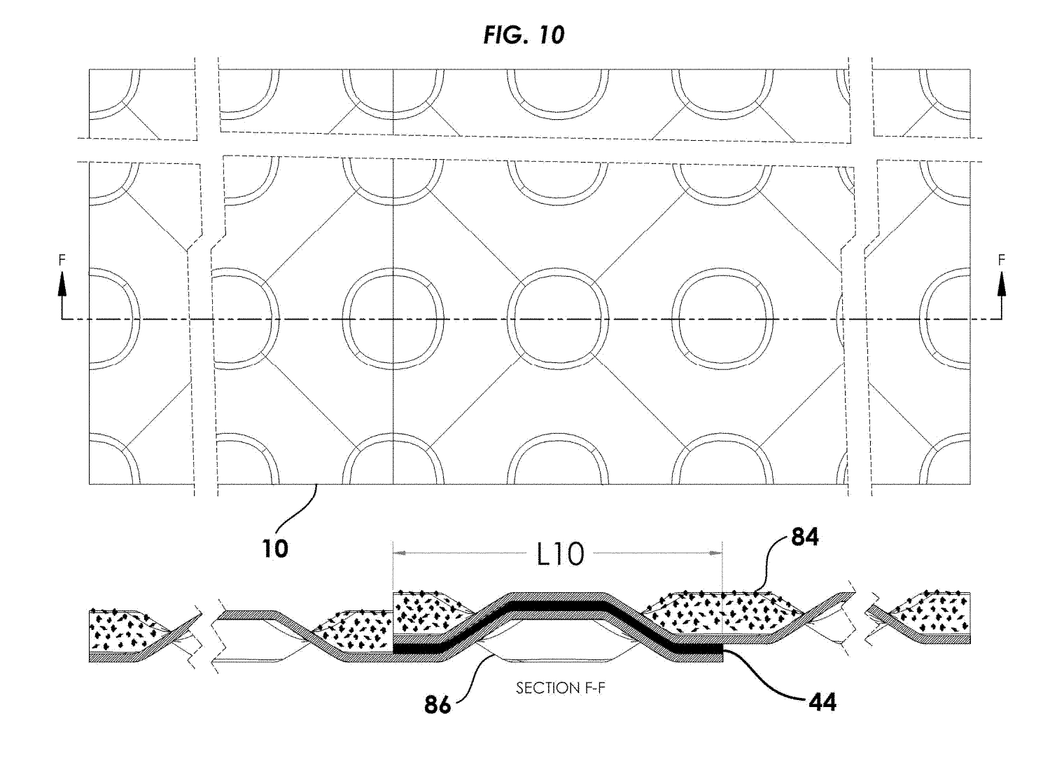

In referring to FIG. 14, when cured and de-molded, the cured transportation matting 10 has the net convoluted surface geometry created by the tooling with alternating peaks and valleys as previously described herein, having the grit material integral to the composite matting top surface with bottom surface being smooth. As shown in the cross-sectional view along line F-F of FIG. 10, the integral co-molded grit produces a rough matting top surface 84 wherein the roughness creates a traction enhancing feature for wheeled and tracked vehicles traversing the matting in the field. In some embodiments the bottom surface 86 is smooth.

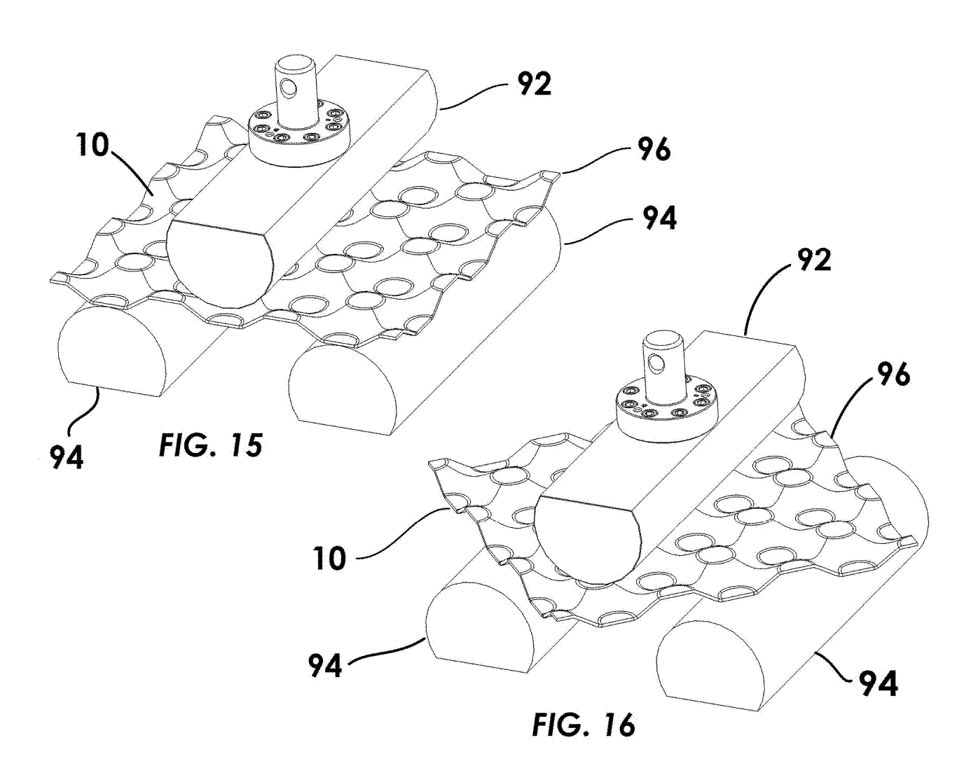

In referring to FIG. 15, in some embodiments the transportation matting strength, stiffness, toughness, and cyclical fatigue values are determined through a three-point bend test of a representative piece 96 of the transportation matting placed in a tensile test machine, where a cylindrical loading nose element 92 is placed on top of the representative test piece and two cylindrical support elements 94 are placed underneath the test piece. The loading nose and support elements are placed in parallel to one another in the plan view. In some embodiments, the test piece is comprised of a 12 inch×12 inch square section cut from the transportation matting where the 4 inch peak-to-peak distance is running parallel to the sides of the test piece cut boundary.

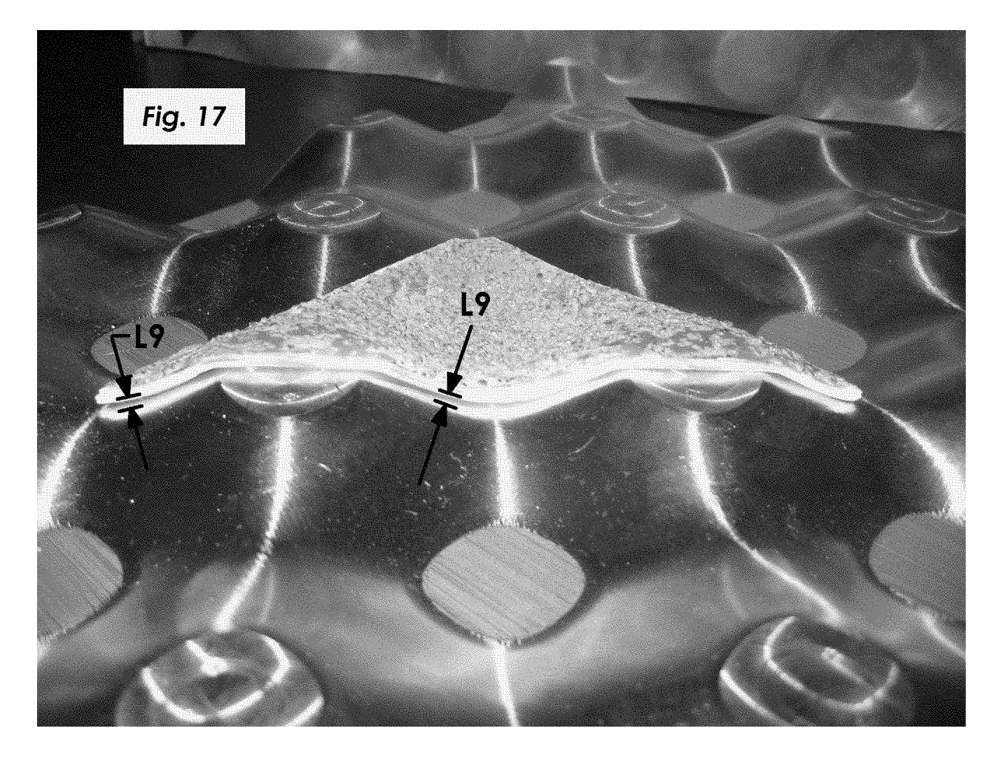

In some embodiments, orthogonal or roll-up mechanical properties of the matting 10 are determined by placing the loading and support elements parallel to the sides of the test plate in the plan view, and displacing the loading nose normal to the plan view to deform the test piece and generate load vs. deflection data under flexure. Similarly, as shown in FIG. 16, diagonal or vehicle support mechanical properties are determined by placing the loading nose 92 and supporting elements 94 at a 45 degree angle with the sides of the test piece 96 relative to the plan view, and displacing the loading nose normal to the plan view to deform the test piece and generate load vs. deflection data under flexure.

A representative test piece of transportation matting subjected to the three-point bend test previously described has vehicle support flexural stiffness about the diagonal axis relative to the sides of the matting of at least 2900 lbf/in at temperatures of −25° F., 72° F., and 125° F.

A representative test piece of transportation matting subjected to the three-point bend test previously described has a vehicle support flexural strength about a diagonal axis relative to the sides of the matting of at least 1800 lbf at −25° F., 72° F., and 125° F.

A representative test piece of transportation matting subjected to the three-point bend test previously described has a vehicle support cyclical fatigue behavior about a diagonal axis relative to the sides of the matting, where the matting can continue to bear at least 2000 accumulated load-unload cycles without flexural strength degradation at −25° F., 72° F., and 125° F.

A representative test piece of transportation matting subjected to the three-point bend test previously described has a vehicle support cyclical fatigue behavior about a diagonal axis relative to the sides of the matting where the matting can continue to bear at least 2000 accumulated load-unload cycles without flexural stiffness degradation at −25° F., 72° F., and 125° F.

A representative test piece of transportation matting subjected to the three-point test previously described has a roll-up flexural stiffness about an orthogonal axis relative to the sides of the matting of at least 500 lbf/in at −25° F., 72° F., and 125° F.

In some embodiments, the transportation matting can sustain 2000 passes by a MTVR vehicle weighing 55,000 lbs whereby the soil rut depth created by the MTVR vehicle wheels can be less than 6 inches and transportation matting damage can be less than 20% by plan area.

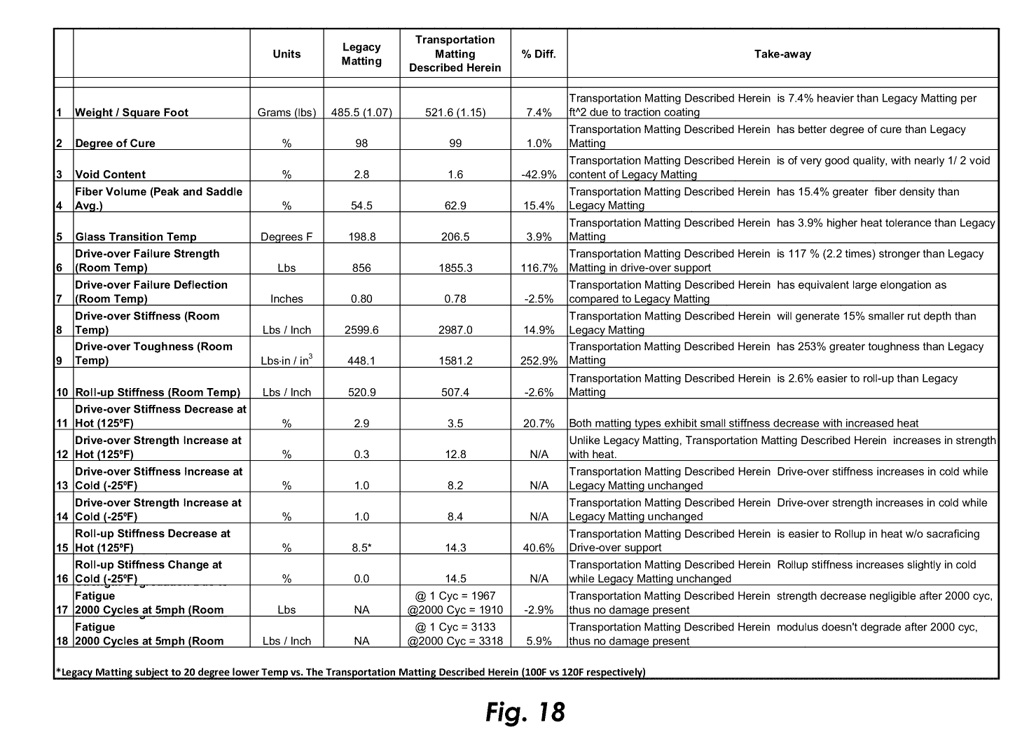

Tabulation of these previously described properties is contained in FIG. 18.

In the event the transportation matting is damaged, with damage including but not limited to cracks, perforations, holes, delamination, fiber pull-out, de-bonding, corrosion, voids, buckling, fatigue, UV degradation, fire exposure, and chemical erosion, the transportation matting described herein can be repaired using transportation matting sections as patches overlaid and adhered via bonding or fastening to the damaged matting regime. In some embodiments, the transportation matting can be repaired using adhesive which includes epoxy, methyl methacrylate (MMA), urethane, or polyurethane adhesive to bond patches to the damaged matting regime.

The transportation matting described herein provides an improvement over legacy transportation matting due to its geometry, processing quality, and constituent make-up. Using a test arrangement as described by FIGS. 15 and 16 and detailed herein, the transportation matting described herein demonstrates superior properties to the Legacy transportation matting, which include greater than 2 times the strength, 250% greater toughness, 15% better soil stabilization with reduced roll-up effort, lower void content, and greater fiber volume fraction. Tabulation of these previously described properties is contained in FIG. 18.

The improved performance of the transportation matting described herein over the legacy transportation matting is due to the constituent glass fiber and resin system properties, as described above, and to geometric differences between the matting surfaces. FIG. 17 contains an image of a section of legacy transportation matting laid over the tooling surface of the transportation matting described herein in the diagonal profile orientation. A distinction leading to the greater vehicle support stiffness of the transportation matting described herein as compared to the legacy transportation matting can be seen in the gap L9 formed between the tool and the matting section in the saddle region between the two peaks. This gap L9, which can be as much as 0.05 inch, indicates that when molded to the tooling surface, the transportation matting described herein has a greater area moment of inertia and thus stiffness in the vehicle support direction, generating higher soil stabilization capacity and improved traffic flow vs legacy transportation matting.

The greater area moment of inertia provided by surface of the transportation matting described herein in the diagonal direction translates into a “sharper” nodal regime when sectioned through the orthogonal direction. A sharper or more defined nodal region provides decreased flexural stiffness about these nodes and results in easier roll-up as compared to the legacy transportation matting. In general, the transportation matting described herein has sharper and more defined surface geometry when molded, especially in the platform of the truncated peak and valley regime, when compared to the legacy transportation matting.

Additional aspects and embodiments of transportation matting are as follows:

1. Transportation matting comprising:

a matting comprising at least two layers of a composite material comprising glass reinforcing fibers embedded in a resin matrix;

the matting having an upper surface and a lower surface and side edges extending in a longitudinal direction, and having a convoluted wave form configuration comprising alternating peaks and valleys;

wherein the matting has a support flexural strength about a diagonal axis relative to the side edges of the matting of at least about 1800 lbf at 72° F.

2. The transportation matting of embodiment 1, wherein the composite material layers are biaxially oriented with fibers at ±45° relative to the side edges of the matting.
3. The transportation matting of any of embodiments 1-2, wherein the composite material layers comprise four non-crimp mat layers, wherein two inner mat layers have an areal density of about 18 oz/yd² and two outer mat layers have an areal density of about 24 oz/yd².
4. The transportation matting of any of embodiments 1-3, wherein the resin matrix is an elastomer modified epoxy vinyl ester with a tensile elongation at failure equal to or greater than 8%.
5. The transportation matting of any of embodiments 1-4, wherein the glass fibers are E-glass and/or S-glass fibers.
6. The transportation matting of any of embodiments 1-5, wherein the matting is about 6 times stiffer in flexure about its diagonal axis than its orthogonal or roll-up axis.
7. The transportation matting of any of embodiments 1-6, wherein the matting is coilable with a preload whereby the matting tends to unroll and lay flat.
8. The transportation matting of any of embodiments 1-7, wherein the matting comprises multiple panels joined along overlapping seams with an adhesive.
9. The transportation matter of embodiment 8, wherein the adhesive is an epoxy, a methyl methacrylate adhesive (MMA), a urethane or a polyurethane.
10. The transportation matting of any of embodiments 8-9, wherein the overlapping seams have shear strength of at least about 2000 psi based on ASTM testing standard D3164.
11. The transportation matting of any of embodiments 1-10, wherein the matting has a flexural stiffness about a diagonal axis relative to the side edges of the matting of at least about 2900 lbf/in.
12. The transportation matting of any of embodiments 1-11, wherein the matting can bear at least 2000 accumulated flexural load-unload cycles without degradation below about 1800 lbf of a flexural strength about a diagonal axis relative to the side edges of the matting.
13. The transportation matting of any of embodiments 1-12, wherein the matting can bear at least 2000 accumulated flexural load cycles without degradation below about 2900 lbf/in of a flexural stiffness about a diagonal axis relative to side edges of the matting.
14. The transportation matting of any of embodiments 1-13, wherein the matting has a roll up flexural stiffness of about 500 lbf/in about an orthogonal or roll-up axis relative to the side edges of the matting.
15. The transportation matting of any of embodiments 1-14, wherein resin of the resin matrix has a glass transition temperature of at least 200° F.
16. The transportation matting of any of embodiments 1-15, wherein the matting has a void content of about 1.6% or less.
17. The transportation matting of any of embodiments 1-16, wherein the matting has a fiber volume fraction of at least about 60% in peak and saddle regions.
18. The transportation matting of any of embodiments 1-17, wherein the resin matrix has a degree of cure equal to or greater than about 99%.
19. The transportation matting of any of embodiments 1-18, wherein a ratio of fiber volume to the cured composite matting volume created by the fiber volume plus resin matrix volume is at least about 62%.
20. The transportation matting of any of embodiments 1-19, wherein the matting has a flexural toughness or specific energy absorption of at least 1500 lb*in/in³ about a diagonal axis relative to the side edges of the matting.
21. The transportation matting of any of embodiments 1-20, further comprising one or more holes in a peripheral region of the matting, the one or more holes configured to facilitate moving of the matting and staking of the matting to a ground surface.
22. The transportation matting of embodiment 21, further comprising a doubler comprising an additional section of the composite matting material bonded or fastened to the matting surface local to each of the one or more holes.
23. The transportation matting of any of embodiments 1-22, wherein the matting has an in-plane peak-to-peak distance (wavelength) of the convoluted wave form when laid flat and measured parallel to the side edges of the matting ranging from 3 inches to 5 inches.
24. The transportation matting of any of embodiments 1-23, wherein the matting has an in-plane peak-to-peak distance (wavelength) of the convoluted wave form when laid flat and measured parallel to the side edges of the matting equal to 4 inches.
25. The transportation matting of any of embodiments 1-24, wherein the matting has an in-plane peak-to-peak distance (wavelength) of the convoluted wave form when laid flat and measured in the diagonal or bias direction from the side edges of the matting ranging from 2.12 inches to 3.54 inches.
26. The transportation matting of any of embodiments 1-25, wherein the matting has an in-plane peak-to-peak distance (wavelength) of the convoluted wave form when laid flat and measured in the diagonal or bias direction from the side edges of the matting equal to 2.83 inches.
27. The transportation matting of any of embodiments 1-26, wherein the matting can be rolled-up with an outer coil diameter of between 3.5 feet and 4.5 feet.
28. The transportation matting of any of embodiments 1-27, wherein the matting has an areal density ranging from 0.8 lbf/ft² to about 1.3 lb/ft².
29. The transportation matting of any of embodiments 1-28, wherein the matting has an areal density of about 1 lbf/ft².
30. The transportation matting of any of embodiments 1-29, wherein the matting has a wall thickness between the upper surface and the lower surface ranging from about 0.3 inch to about 0.13 inch.
31. The transportation matting of any of embodiments 1-30, wherein the matting has a wall thickness between the upper surface and the lower surface of about 0.10 inch.
32. The transportation matting of any of embodiments 1-31, wherein the convoluted wave form configuration of the matting surface is a 3-dimensional truncated sine wave with an amplitude of 5/16 inch, and a matting thickness envelope of ⅝ from a peak on the upper surface to a valley on the lower surface of the matting.
33. The transportation matting of any of embodiments 1-32, wherein the matting peaks and valleys are oriented in an orthogonal repeating pattern, with the largest peak-to-peak measurement extending parallel to the side edges of the matting.
34. The transportation matting of any of embodiments 1-33, wherein a distance between peaks is equal to a distance between valleys for both orthogonal and diagonal directions.
35. The transportation matting of any of embodiments 1-34, wherein clipped or truncated peaks and valleys of the matting create a platform section at each instance in the plan view, with a squircle shape comprising a square and a circle in which sides of the square section are arched in a convex form, having rounded corners, and a length and a width each about 1 inch.
36. The transportation matting of any of embodiments 1-35, wherein a curved region located between adjacent peaks in a diagonal direction is a saddle region having a cusp midway between the adjacent peaks at an inflection of the saddle.
37. The transportation of any of embodiments 1-36, wherein the matting is configured to sustain 2000 passes by a MTVR vehicle weighing 55,000 lbs, whereby a soil rut depth created by the MTVR vehicle wheels is less than about 6 inches.
38. The transportation of any of embodiments 1-37, wherein the matting is configured to sustain 2000 passes by a MTVR vehicle weighing 55,000 lbs, whereby damage to the matting created by the MTVR vehicle wheels is less than 20% by plan area.
39. The transportation matting of any of embodiments 1-38, wherein the matting is configured to unroll or uncoil in less than about 1 minute upon release from a coiled configuration.
40. The transportation matting of any of embodiments 1-39, wherein the matting is configured to be deployed at a rate of at least 5,000 square feet per man hour.
41. The transportation matting of any of embodiments 1-40, wherein the matting is configured to be deployed at a rate of about 50,000 square feet per man hour.
42. The transportation matting of any of embodiments 1-41, further comprising a repair patch overlaid and adhered or bonded to a damaged section of the matting.
43. The transportation matting of embodiment 42, wherein the damaged section is a crack, perforation, hole, delamination, fiber pull-out, debonding, corrosion, void, buckling, fatigue, ultraviolet degradation, fire exposure, or chemical erosion.
44. A method of making the transportation matting of any of embodiments 1-43, comprising:

providing tooling having a convoluted surface comprising alternating peaks and valleys that match the convoluted surface configuration of the matting;

laying up layers of fiber against the convoluted surface of the tooling;

sealing the layers of fiber within the tooling;

infusing resin through the layers of fiber within the tooling; and

allowing the resin to cure.

45. Tooling for the transportation matting of any of embodiments 1-43, wherein the tooling comprises a mold having a convoluted surface comprising alternating peaks and valleys that match the convoluted surface configuration of the matting.
46. A method for stabilizing a ground surface comprising:

providing the transportation matting of any of the embodiments of 1-43, and deploying the transportation matting on a ground surface.

As used herein, “consisting essentially of” allows the inclusion of materials or steps that do not materially affect the basic and novel characteristics of the claim. Any recitation herein of the term “comprising,” particularly in a description of components of a composition or in a description of elements of a device, can be exchanged with “consisting essentially of” or “consisting of.”

It will be appreciated that the various features of the embodiments described herein can be combined in a variety of ways. For example, a feature described in conjunction with one embodiment may be included in another embodiment even if not explicitly described in conjunction with that embodiment.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

The present invention has been described in conjunction with certain preferred embodiments. It is to be understood that the invention is not limited to the exact details of construction, operation, exact materials or embodiments shown and described, and that various modifications, substitutions of equivalents, alterations to the compositions, and other changes to the embodiments disclosed herein will be apparent to one of skill in the art.

What is claimed is:

1. Transportation matting comprising:
a matting comprising at least two layers of a composite material comprising glass reinforcing fibers embedded in a resin matrix;
the matting having an upper surface and a lower surface and side edges extending in a longitudinal direction, and having a convoluted wave form configuration comprising alternating peaks and valleys;
wherein the matting has a support flexural strength about a diagonal axis relative to the side edges of the matting of at least about 1800 lbf at 72° F.

2. The transportation matting of claim 1, wherein the composite material layers are biaxially oriented with fibers at ±45° relative to the side edges of the matting.

3. The transportation matting of claim 1, wherein the composite material layers comprise four non-crimp mat layers, wherein two inner mat layers have an areal density of about 18 oz/yd² and two outer mat layers have an areal density of about 24 oz/yd².

4. The transportation matting of claim 1, wherein the resin matrix is an elastomer modified epoxy vinyl ester with a tensile elongation at failure equal to or greater than 8%.

5. The transportation matting of claim 1, wherein the glass fibers are E-glass and/or S-glass fibers.

6. The transportation matting of claim 1, wherein the matting is about 6 times stiffer in flexure about its diagonal axis than its orthogonal or roll-up axis.

7. The transportation matting of claim 1, wherein the matting is coilable with a preload whereby the matting tends to unroll and lay flat.

8. The transportation matting of claim 1, wherein the matting comprises multiple panels joined along overlapping seams with an adhesive.

9. The transportation matter of claim 8, wherein the adhesive is an epoxy, a methyl methacrylate adhesive (MMA), a urethane or a polyurethane.

10. The transportation matting of claim 8, wherein the overlapping seams have shear strength of at least about 2000 psi based on ASTM testing standard D3164.

11. The transportation matting of claim 1, wherein the matting has a flexural stiffness about a diagonal axis relative to the side edges of the matting of at least about 2900 lbf/in.

12. The transportation matting of claim 1, wherein the matting can bear at least 2000 accumulated flexural load-unload cycles without degradation below about 1800 lbf of a flexural strength about a diagonal axis relative to the side edges of the matting.

13. The transportation matting of claim 1, wherein the matting can bear at least 2000 accumulated flexural load cycles without degradation below about 2900 lbf/in of a flexural stiffness about a diagonal axis relative to side edges of the matting.

14. The transportation matting of claim 1, wherein the matting has a roll up flexural stiffness of about 500 lbf/in about an orthogonal or roll-up axis relative to the side edges of the matting.

15. The transportation matting of claim 1, wherein resin of the resin matrix has a glass transition temperature of at least 200° F.

16. The transportation matting of claim 1, wherein the matting has a void content of about 1.6% or less.

17. The transportation matting of claim 1, wherein the matting has a fiber volume fraction of at least about 60% in peak and saddle regions.

18. The transportation matting of claim 1, wherein the resin matrix has a degree of cure equal to or greater than about 99%.

19. The transportation matting of claim 1, wherein a ratio of fiber volume to the cured composite matting volume created by the fiber volume plus resin matrix volume is at least about 62%.

20. The transportation matting of claim 1, wherein the matting has a flexural toughness or specific energy absorption of at least 1500 lb*in/in³ about a diagonal axis relative to the side edges of the matting.

21. The transportation matting of claim 1, further comprising one or more holes in a peripheral region of the matting, the one or more holes configured to facilitate moving of the matting and staking of the matting to a ground surface.

22. The transportation matting of claim 21, further comprising a doubler comprising an additional section of the composite matting material bonded or fastened to the matting surface local to each of the one or more holes.

23. The transportation matting of claim 1, wherein the matting has an in-plane peak-to-peak distance (wavelength) of the convoluted wave form when laid flat and measured parallel to the side edges of the matting ranging from 3 inches to 5 inches.

24. The transportation matting of claim 1, wherein the matting has an in-plane peak-to-peak distance (wavelength) of the convoluted wave form when laid flat and measured parallel to the side edges of the matting equal to 4 inches.

25. The transportation matting of claim 1, wherein the matting has an in-plane peak-to-peak distance (wavelength) of the convoluted wave form when laid flat and measured in the diagonal or bias direction from the side edges of the matting ranging from 2.12 inches to 3.54 inches.

26. The transportation matting of claim 1, wherein the matting has an in-plane peak-to-peak distance (wavelength) of the convoluted wave form when laid flat and measured in the diagonal or bias direction from the side edges of the matting equal to 2.83 inches.

27. The transportation matting of claim 1, wherein the matting can be rolled-up with an outer coil diameter of between 3.5 feet and 4.5 feet.

28. The transportation matting of claim 1, wherein the matting has an areal density ranging from 0.8 lbf/ft² to about 1.3 lb/ft².

29. The transportation matting of claim 1, wherein the matting has an areal density of about 1 lbf/ft².

30. The transportation matting of claim 1, wherein the matting has a wall thickness between the upper surface and the lower surface ranging from about 0.3 inch to about 0.13 inch.

31. The transportation matting of claim 1, wherein the matting has a wall thickness between the upper surface and the lower surface of about 0.10 inch.

32. The transportation matting of claim 1, wherein the convoluted wave form configuration of the matting surface is a 3-dimensional truncated sine wave with an amplitude of 5/16 inch, and a matting thickness envelope of ⅝ from a peak on the upper surface to a valley on the lower surface of the matting.

33. The transportation matting of claim 1, wherein the matting peaks and valleys are oriented in an orthogonal repeating pattern, with the largest peak-to-peak measurement extending parallel to the side edges of the matting.

34. The transportation matting of claim 1, wherein a distance between peaks is equal to a distance between valleys for both orthogonal and diagonal directions.

35. The transportation matting of claim 1, wherein clipped or truncated peaks and valleys of the matting create a platform section at each instance in the plan view, with a squircle shape comprising a square and a circle in which sides of the square section are arched in a convex form, having rounded corners, and a length and a width each about 1 inch.

36. The transportation matting of claim 1, wherein a curved region located between adjacent peaks in a diagonal direction is a saddle region having a cusp midway between the adjacent peaks at an inflection of the saddle.

37. The transportation of claim 1, wherein the matting is configured to sustain 2000 passes by a MTVR vehicle weighing 55,000 lbs, whereby a soil rut depth created by the MTVR vehicle wheels is less than about 6 inches.

38. The transportation of claim 1, wherein the matting is configured to sustain 2000 passes by a MTVR vehicle weighing 55,000 lbs, whereby damage to the matting created by the MTVR vehicle wheels is less than 20% by plan area.

39. The transportation matting of claim 1, wherein the matting is configured to unroll or uncoil in less than about 1 minute upon release from a coiled configuration.

40. The transportation matting of claim 1, wherein the matting is configured to be deployed at a rate of at least 5,000 square feet per man hour.

41. The transportation matting of claim 1, wherein the matting is configured to be deployed at a rate of about 50,000 square feet per man hour.

42. The transportation matting of claim 1, further comprising a repair patch overlaid and adhered or bonded to a damaged section of the matting.

43. The transportation matting of claim 42, wherein the damaged section is a crack, perforation, hole, delamination, fiber pull-out, debonding, corrosion, void, buckling, fatigue, ultraviolet degradation, fire exposure, or chemical erosion.

44. A method of making the transportation matting of claim 1, comprising:
providing tooling having a convoluted surface comprising alternating peaks and valleys that match the convoluted surface configuration of the matting;
laying up layers of fiber against the convoluted surface of the tooling;
sealing the layers of fiber within the tooling;
infusing resin through the layers of fiber within the tooling; and
allowing the resin to cure.

45. Tooling for the transportation matting of claim 1, wherein the tooling comprises a mold having a convoluted surface comprising alternating peaks and valleys that match the convoluted surface configuration of the matting.
